(19) United States
(12) Patent Application Publication
(10) Pub. No.: US 2020/0129358 A1
(43) Pub. Date: Apr. 30, 2020

(54) PIVOTING DENTAL CABINET ASSEMBLY

(71) Applicant: Robert A. Shaffer, Minneapolis, MN (US)

(72) Inventor: Robert A. Shaffer, Minneapolis, MN (US)

(21) Appl. No.: 16/663,938

(22) Filed: Oct. 25, 2019

Related U.S. Application Data
(60) Provisional application No. 62/750,334, filed on Oct. 25, 2018.

(51) Int. Cl. A61G 15/16; A47B 83/04; A47B 49/00; A47B 81/06; F16M 13/02

(52) U.S. Cl. CPC A61G 15/16; A47B 83/045; A47B 49/00; F16M 2200/06; F16M 13/022; A47B 2220/0077; A47B 81/061

(57) ABSTRACT

A dental cabinet assembly includes a stationary support defining a rotational axis. At least one cabinet is coupled with the stationary support and is configured to pivot about the rotational axis relative to the stationary support.

### BACKGROUND

Design of dental rooms involves various tradeoffs related to space, efficiency and accessibility. For example, there is a desire to reduce the space required by dental rooms so as to fit multiple dental rooms within a specified area. However, reduction in space of a dental room can reduce accessibility to and/or efficiency of the room, for example to not allow access to disabled patients in a wheelchair. Further still, dentists request a large amount of cabinet space so as to offer greater efficiency and flexibility in performing various dental operations.

### SUMMARY

One aspect of concepts presented herein relates to a dental cabinet assembly including a stationary support defining a rotational axis. At least one cabinet is coupled with the stationary support and is configured to pivot about the rotational axis relative to the stationary support.

Another aspect includes a dental room having a dental chair, side walls defining an opening and a dental cabinet assembly positioned within the opening. The dental cabinet assembly includes at least one cabinet defining an outer profile and is rotatable about a rotational axis between first and second positions. In the first position, a first distance is established between the outer profile and one of the side walls. In a second position, a second distance is established between the outer profile and said one of the side walls. The second distance is greater than the first distance.

### BRIEF DESCRIPTION OF THE DRAWINGS

FIG. 1 is a top view of an example dental room having a cabinet assembly in a first position.

FIG. 2 is a top view of the example dental room of FIG. 1 having the cabinet assembly in a second position.

FIG. 3 is a top view of a cabinet assembly and dental chair.

FIG. 4 is a bottom view of a cabinet assembly and a dental chair.

FIG. 5 is a side view of a cabinet assembly and a dental chair.

FIG. 6 is a front view of a cabinet assembly and a dental chair.

FIG. 7 is a rear view of a cabinet assembly.

### DESCRIPTION

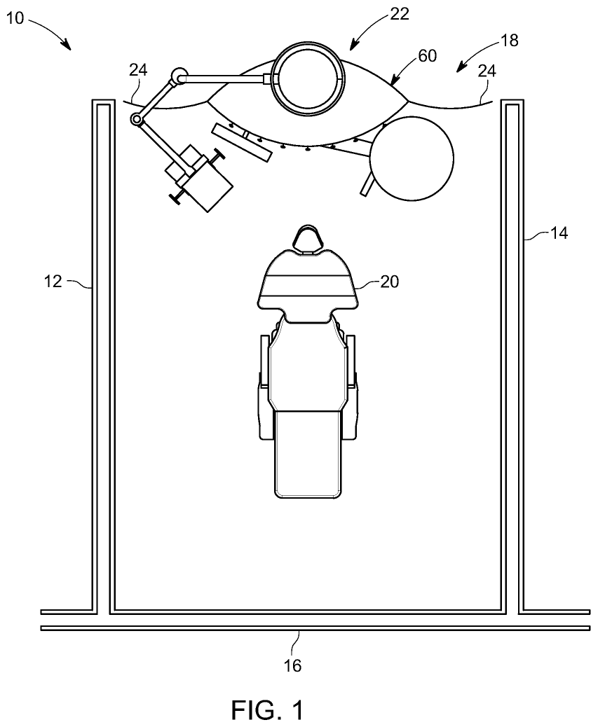

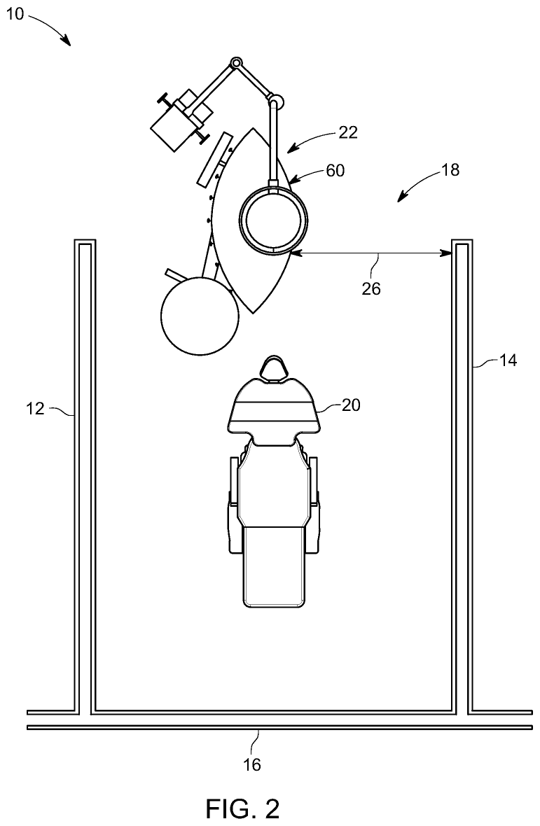

With reference to FIGS. 1 and 2, a dental room 10 includes opposed side walls 12 and 14 and a bottom wall 16 adjoining the first and second side walls 12 and 14. Positioned between the side walls 12 and 14 and opposite the bottom wall 16 is an opening 18 providing access to the dental room 10. A dental chair 20 and cabinet assembly 22 are positioned within the dental room 10. The dental chair 20 is centrally positioned within the room 10, whereas the cabinet assembly 22 is positioned proximate the opening 18. In a first configuration or position of the cabinet assembly 22 as illustrated in FIG. 1, the cabinet assembly 22 substantially blocks the opening 18. In a second configuration or position of the cabinet assembly 22 as illustrated in FIG. 2, the cabinet assembly 22 is rotated or pivoted such that access is allowed to dental room 10 through opening 18.

In the first configuration of FIG. 1, the cabinet assembly 22 includes outwardly extending arms 24 that extend from the cabinet assembly 22 proximate the side walls 12, 14 so as to enhance privacy within the room 10 (i.e., with respect to an interior space of room 10 bound by walls 12, 14, 16 and cabinet 22). Accordingly, these arms 24 can extend vertically along an entire height of the cabinet assembly 22, or otherwise a portion of the height of the cabinet assembly 22 as desired. The arms 24 can include a free end that can be selectively positioned with respect to the cabinet assembly 22 by rotating the arms 24 with respect to the cabinet assembly. In other embodiments, the arms 24 can be supported linearly with respect to the cabinet assembly 22. In other embodiments, the arms 24 can be eliminated. When used, the arms 24 can be rotationally coupled (or slidably coupled) with the cabinet assembly 22 (e.g., through a piano hinge or slide mechanism) such that in the second configuration, the arms 24 are folded into the cabinet assembly 22 so as to enable easier rotation of the cabinet assembly 22 with respect to the room 10 and allow larger separation between the cabinet assembly 22 and the side walls 12 and 14. In the second configuration of FIG. 2, an access portion 26 is created that allows access to the room 10. In one embodiment, the access portion 26 has a width to accommodate a wheelchair (i.e., at least approximately 32 inches). The access portion 26 can include access openings on one or both sides of the cabinet assembly 22. To that end, although cabinet assembly 22 is centrally located between walls 12 and 14 in FIGS. 1 and 2, cabinet assembly 22 can be positioned closer to wall 12 or 14 as desired.

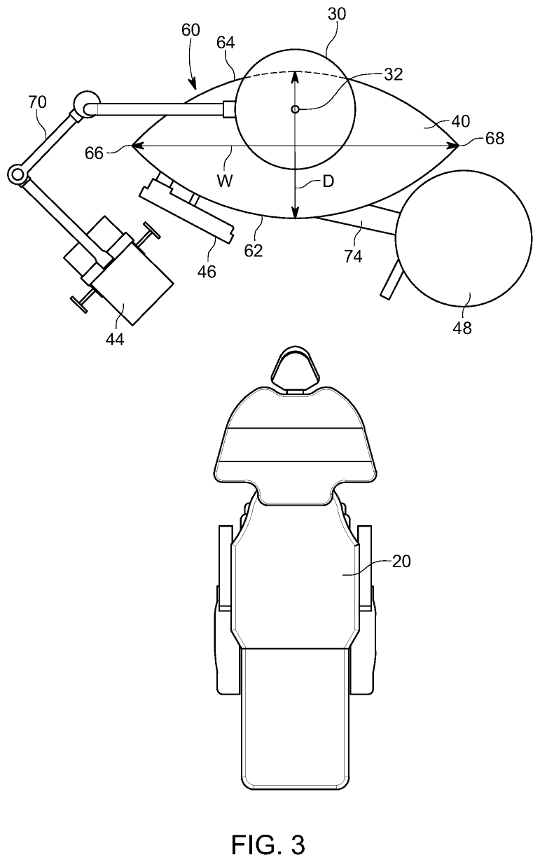

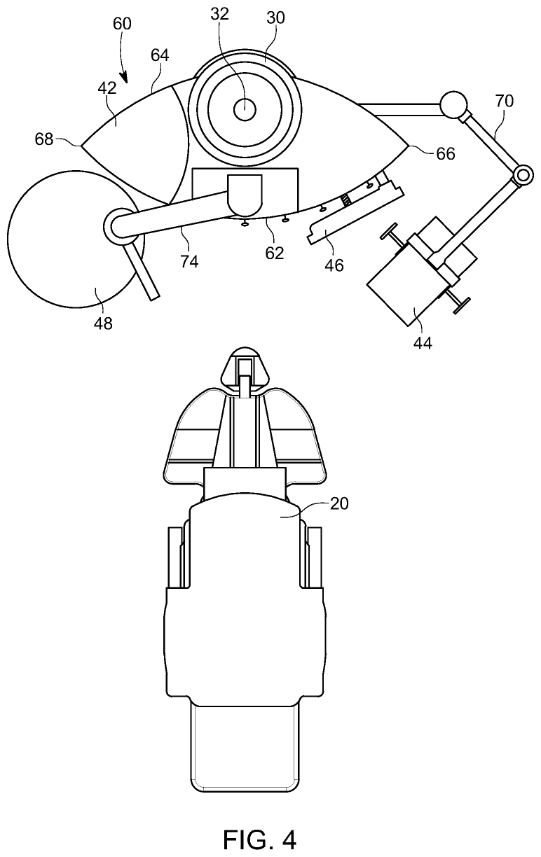

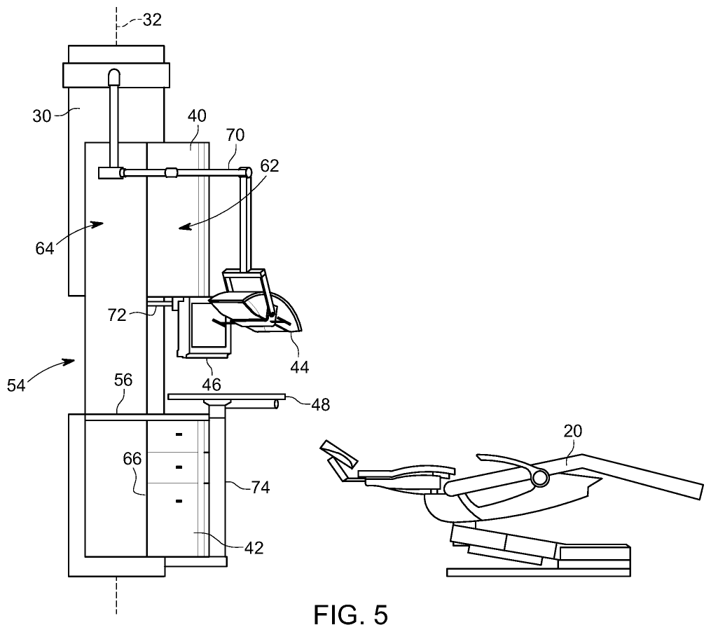

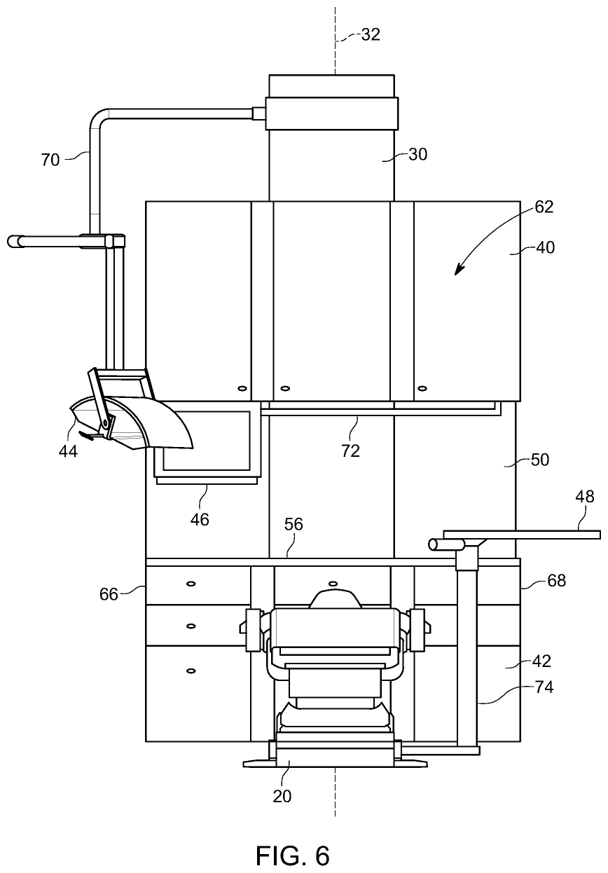

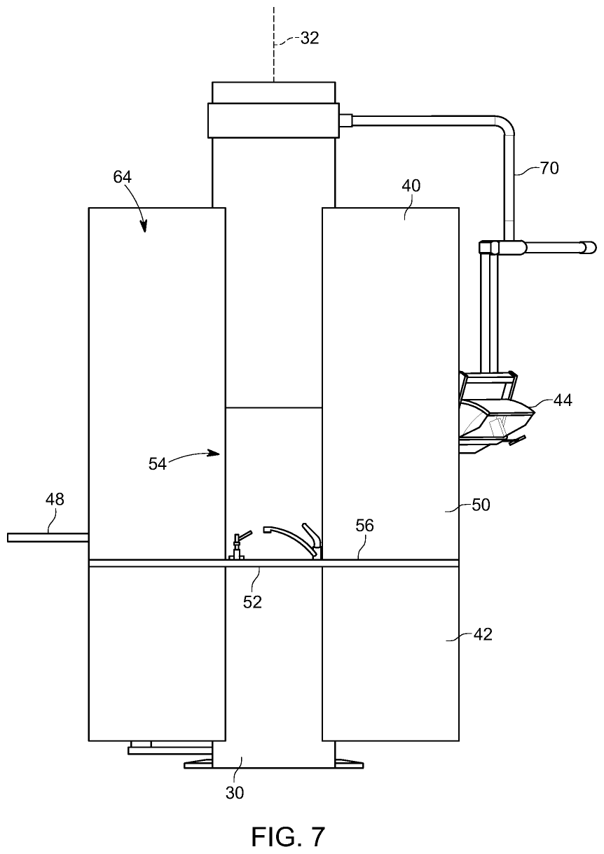

With further reference to FIGS. 3-7, the cabinet assembly 22 includes a vertically extending stationary support 30 defining a rotational axis 32. In the embodiment illustrated, the support 30 is a tube configured to rotationally support storage and other equipment useful in performing dental operations. In the example illustrated, this equipment includes an upper cabinet 40, a lower cabinet 42, a light 44, a monitor 46 and an accessory table 48. Additionally, in the embodiment illustrated, the cabinet assembly 22 also includes a middle cabinet support 50 that connects the upper cabinet 40 with the lower cabinet 42. The middle cabinet support 50 can be integral with portions of the upper cabinet 40 and/or lower cabinet 42, or separate therefrom.

In one embodiment, the equipment is coupled so as to rotate together about the support 30. In an alternative embodiment, the support 30 is rotationally mounted (e.g., to the floor) and configured to rotate (e.g., through a bearing such as a thrust bearing) with respect to the floor. In still a further embodiment, support 30 is stationary and equipment and/or cabinets are rotatably mounted thereto. In a further embodiment, the support 30 can also be mounted to the ceiling to provide additional structural strength to the support 30.

The support 30 can be configured to accommodate various utilities (e.g., plumbing conduits, electrical wiring) useful in dental procedures. These utilities can be positioned within the support 30 and do not rotate about the rotational axis. For example, these utilities include a water supply, a water drain, a vacuum, compressed air, oxygen tubing, nitrous tubing, electrical connection(s) and other utilities as desired. These utilities can extend from the ceiling (e.g., through a top opening in the support 30) and/or can extend from the floor (e.g., through a lower opening in the support 30).

In addition, the support 30 can accommodate other equipment, for example a sink 52. The sink 52 can be directly supported by the support 30 and positioned as desired with respect to other equipment coupled with the cabinet assembly 22 and remain stationary upon rotation of the cabinet assembly 22. In the embodiment illustrated, the sink 52 is positioned within a rear opening 54 of the support 30. The rear opening 54 is positioned on an opposite side of cabinet assembly 22 from dental chair 20. In this position, a dentist, patient or other person can wash his/her hands through opening 54 prior to entering the dental room 10. In a further embodiment, the support 30 can accommodate lighting within the opening 54, as desired.

Cabinets 40 and 42 can be mounted or otherwise coupled to the support 30 in a variety of different ways. In one embodiment, the cabinets 40 and 42 can include suitable hardware that allows quick engagement and disengagement of cabinets 40 and 42 to and from support 30. In a further embodiment, lower cabinet 42 can be freestanding and supported by wheels such that an operator can easily move the lower cabinet 42 in and out of engagement with the support 30. Moreover, the cabinets 40 and 42 can be divided into multiple sections individually connectable with support 30 or as one unit. The lower cabinet 42 can also be configured to support a working surface 56.

The cabinets 40 and 42 form an outer profile 60 defined by a maximum outer dimension of the cabinets 40 and 42 in a plane that is orthogonal to the rotational axis 32. The profile 60, in one embodiment, surrounds the rotational axis 32. Stated another way, for any plane that is parallel to and includes the rotational axis 32, the plane will intersect the outer profile at two positions. Alternatively, outer profile 60 can be positioned with respect to the rotational axis 32 such that, for at least one plane that is parallel to and intersects the rotational axis 32, the at least one plane will intersect the outer profile in two positions on opposite sides of the rotational axis 32.

The outer profile 60 can be formed of different shapes and dimensions as desired, and cabinets 40 and 42 need not form the same or a similar outer profile. In the embodiment illustrated, outer profile 60 is formed of opposed arcuate surfaces 62 and 64 that join at opposite edges 66 and 68. Accordingly, the profile 60 can be said to be almond-shaped, but can form other shapes such as rectangular, elliptical, oval, triangular and others. The profile 60 defines a width W and a depth D, the width being defined as the maximum dimension of the profile 60 in a first direction and the depth being defined as the maximum dimension of the profile 60 in a second direction, orthogonal to the first direction. In one embodiment, both the width W and the depth D extend to opposite sides of the rotational axis. For example, the width W can be defined as the distance between edges 66 and 68 (which are located on opposite sides of axis 32), whereas the depth D can be defined as a distance between surfaces 62 and 64 by a line that intersects rotational axis 32 and is approximately (or exactly) a midpoint between edges 66 and 68.

The width W of the outer profile 60 is greater than the depth D. When rotated from the first position of FIG. 1 to the second position of FIG. 2, then, the access portion 26 is created that allows wider objects to enter the room 10. In one example, access portion 26 can be large enough to accommodate a patient in a wheelchair. In such a situation, dental chair 20 can be configured such that the dental chair 20 supports the patient in the wheelchair.

The light 44, monitor 46 and table 48 can be coupled with the support 30 in a number of different ways. For example, the light 44 can be coupled to the support 30 with an adjustable arm assembly 70. The monitor 46 can be coupled with a suitable rack 72 that is coupled with the upper cabinet 40. The table 48 can be coupled with the support 30 through an adjustable arm assembly 74.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A cabinet assembly for positioning in a dental room, comprising:
a stationary support defining a rotational axis;
at least one of a light, a monitor, a table and a work surface coupled to the stationary support and configured to rotate about the rotational axis;
at least one cabinet coupled to the stationary support and configured to pivot about the rotational axis, the at least one cabinet defining an outer profile having a width and a depth, the width being defined as a maximum dimension of the outer profile in a first direction that is parallel to the rotational axis and the depth being defined as a maximum dimension of the outer profile in a second direction that is orthogonal to the first direction, the width being greater than the depth.

2. The cabinet assembly of claim 1, further comprising at least one of a plumbing conduit and an electrical wire positioned within the stationary support.

3. The cabinet assembly of claim 1, further comprising a sink supported by the stationary support.

4. The cabinet assembly of claim 3, wherein the sink intersects the rotational axis.

5. The cabinet assembly of claim 1, wherein the stationary support forms a tube and the at least one cabinet is mounted to the tube.

6. The cabinet assembly of claim 1, wherein the at least one cabinet includes an upper cabinet and a lower cabinet spaced apart from the lower cabinet, the lower cabinet supporting a working surface.

7. The cabinet assembly of claim 1, further comprising at least one arm supported by the at least one cabinet along an axis parallel to the rotational axis, said at least one arm including a free end configured to be positioned at a selected distance from the rotational axis.

8. A dental room having two sidewalls and an open end, comprising:
a dental chair positioned between two side walls; and
a cabinet assembly positioned between the two side walls at the open end and configured to pivot about a rotational axis from a first orientation to a second orientation relative to the dental chair, wherein the cabinet assembly includes a cabinet defining an outer profile extending about the rotational axis, the outer profile defining a width extending in a first direction that is parallel to the rotational axis and a depth extending in a second direction that is orthogonal to the first direction and the rotational axis, wherein the width is greater than the depth.

9. The dental room of claim 8, wherein the dental chair defines a major axis and wherein the cabinet intersects with the major axis.

10. The dental room of claim 9, wherein the rotational axis intersects the major axis.

11. The dental room of claim 9, wherein the depth of the outer profile is greater proximate the rotational axis than at opposed edges spaced apart from the rotational axis.

12. The dental room of claim 11, wherein the outer profile is almond shaped.

13. The dental room of claim 12, wherein an access portion defined as a minimum distance between the first side wall and the outer profile is greater in the second orientation than the first orientation.

14. The dental room of claim 8, wherein the cabinet assembly further comprises at least one of a light, a monitor, a table and a work surface coupled to the stationary support and configured to rotate about the rotational axis.

15. A method, comprising:
positioning a dental chair within a room defined by first and second sidewalls;
positioning a cabinet assembly between the first and second sidewalls, the cabinet assembly including a stationary support and at least one cabinet, the at least one cabinet defining an outer profile extending about the rotational axis, the outer profile defining a width extending in a first direction that is parallel to the rotational axis and a depth extending in a second direction that is orthogonal to the first direction and the rotational axis, wherein the width is greater than the depth.

16. The method of claim 15, further comprising:
rotating the cabinet assembly from a first orientation to a second orientation such that a distance from the outer profile to the first sidewall is increased.

17. The method of claim 15, further comprising:
coupling at least one of a light, a monitor, a table and a work surface to the stationary support for rotation about the rotational axis.
